(19) United States
(12) Patent Application Publication
(10) Pub. No.: US 2010/0250334 A1
(43) Pub. Date: Sep. 30, 2010

(54) DYNAMIC PRINT JOB PROGRAMMING AS A FUNCTION OF RECIPIENT RELATIONSHIP

(75) Inventors: Michael E. Farrell, Webster, NY (US); Javier A. Morales, Rochester, NY (US)

Correspondence Address: Xerox Corporation;c/o ORTIZ & LOPEZ, PLLC, P. O. BOX 4484, ALBUQUERQUE, NM, 87196-4484, US

(73) Assignee: Xerox Corporation

(21) Appl. No.: 12/415,786

(22) Filed: Mar. 31, 2009

(51) Int. Cl. G06Q 30/00; G06Q 10/00; B42D 15/00

(52) U.S. Cl. 705/10; 283/56; 705/14.48

(57) ABSTRACT

The apparent print quality of transaction promotions are matched to their recipients such that those more likely to respond favorably receive higher quality materials. Of the documents people receive, many, such as certain billing statements, also contain transaction promotions. Submitting a print job to a printer instructs it to produce a document by processing a document description. The document description can include a transaction promotion description. The transaction promotion can be printed at one of a number of predetermined quality levels by varying the document description, the print job, or the transaction promotion description. Knowledge of the intended recipient allows for the determination of a recipient quality level matching one of the predetermined quality levels. The document is then produced with a transaction promotion having a recipient based quality level.

### TECHNICAL FIELD

Embodiments are related to printing and more specifically to the automated and dynamic creation of print jobs that, when processed, produce documents containing transaction promotions that are customized for the intended recipient.

### BACKGROUND

Many modern printing facilities can print a document onto a variety of media using a variety of inks or dyes, can produce a variety of document finishings, and can package the document with any of a variety of bindings. The selection of different finishes, color gamuts, media, and bindings has a great effect on the document appearance and on the cost to produce the document. For example, rendering a document in black and white onto inexpensive printer paper is far less expensive than rendering it in color onto glossy card stock. Higher quality documents and transaction promotions are more expensive to produce.

People making transaction decisions often react strongly to the quality of transaction promotions, also known as advertisements. A high quality transaction promotion is more likely to entice a transaction than a low quality transaction promotion. Furthermore, some types of people are more likely to respond with actual transactions. For example, wealthy people are more likely to buy expensive jewelry in response to a transaction promotion. Less affluent people, however, are known to purchase expensive jewelry but exhibit a lower response rate. Systems and methods for matching the quality of transaction promotions to the likelihood that a recipient would favorably respond are needed.

### BRIEF SUMMARY

Aspects of the embodiments address limitations and flaws in the prior art by analyzing recipient data and automatically modifying transaction promotions based on that analysis.

It is therefore an aspect of the embodiments to describe transaction promotions at a number of different quality levels. A single transaction promotion concept can be described by a single transaction promotion description that is printed at varying levels of quality. Alternatively, the single transaction promotion concept can be described by a number of different transaction promotion descriptions, each having a different quality level. Different transaction promotion concepts require different descriptions although the numerous descriptions for numerous concepts can be included in a single document description from which one description is selected.

It is also an aspect of the embodiments to produce a document description. A document description describes a document in such a manner that a printing system can render it into a document. Page description languages (PDLs) such as post script are commonly used to describe documents. As such, most document descriptions are electronic data files of PDL instructions, commands, and data.

It is a further aspect of the embodiments to choose an intended recipient. An intended recipient is a person or entity who is intended to receive a printed document. For example, a utility company would choose one of its customers as the intended recipient of a monthly utility bill. Utility bills often contain transaction promotions, also known as advertisements. The intended recipient is usually also the recipient who actually receives the document.

It is an additional aspect of the embodiments to determine a recipient quality level matching one of the quality levels. The recipient quality level is an estimate of the probability that the recipient can or will respond to the transaction promotion. For example, a high net worth individual is more likely to respond to a transaction promotion advertising private jet aircraft. Additionally, an individual who is known to have previously bought jet aircraft is more likely to purchase another.

It is a yet further aspect of the embodiments to produce a print job that when processed results in printing the document that is described by the document description. The printed document includes a transaction promotion having a quality level matching the recipient quality level. This can be accomplished by customizing the print job, the document description, or the transaction promotion description.

### BRIEF DESCRIPTION OF THE DRAWINGS

The accompanying figures, in which like reference numerals refer to identical or functionally similar elements throughout the separate views and which are incorporated in and form a part of the specification, further illustrate the present invention and, together with the background of the invention, brief summary of the invention, and detailed description of the invention, serve to explain the principles of the present invention

FIG. 1 illustrates a system presenting a document containing a customized transaction promotion to a recipient in accordance with aspects of the embodiments;

FIG. 2 illustrates a system determining a recipient quality level in accordance with aspects of the embodiments;

FIG. 3 illustrates producing transaction promotion descriptions from transaction promotion concepts in accordance with aspects of the embodiments;

FIG. 4 illustrates a high level flow diagram of producing a document including a transaction promotion described by a set of transaction promotion descriptions in accordance with aspects of the embodiments;

FIG. 5 illustrates a high level flow diagram of producing a document including a transaction promotion described by a single transaction promotion description rendered at differing quality levels in accordance with aspects of the embodiments; and

FIG. 6 illustrates a high level flow diagram of producing a document including a transaction promotion described by one of a set of transaction promotion descriptions in accordance with aspects of the embodiments.

### DETAILED DESCRIPTION OF THE INVENTION

The particular values and configurations discussed in these non-limiting examples can be varied and are cited merely to illustrate embodiments and are not intended to limit the scope of the invention.

The quality of transaction promotions are matched to their recipients such that those more likely to respond favorably receive higher quality materials. Of the documents people receive, many, such as certain billing statements, also contain transaction promotions. Submitting a print job to a printer instructs it to produce a document by processing a document description. The document description can include a transaction promotion description. The transaction promotion can be printed at one of a number of predetermined quality levels by varying the document description, the print job, or the transaction promotion description. Knowledge of the intended recipient allows for the determination of a recipient quality level matching one of the predetermined quality levels. The document is then produced with a transaction promotion having a recipient based quality level.

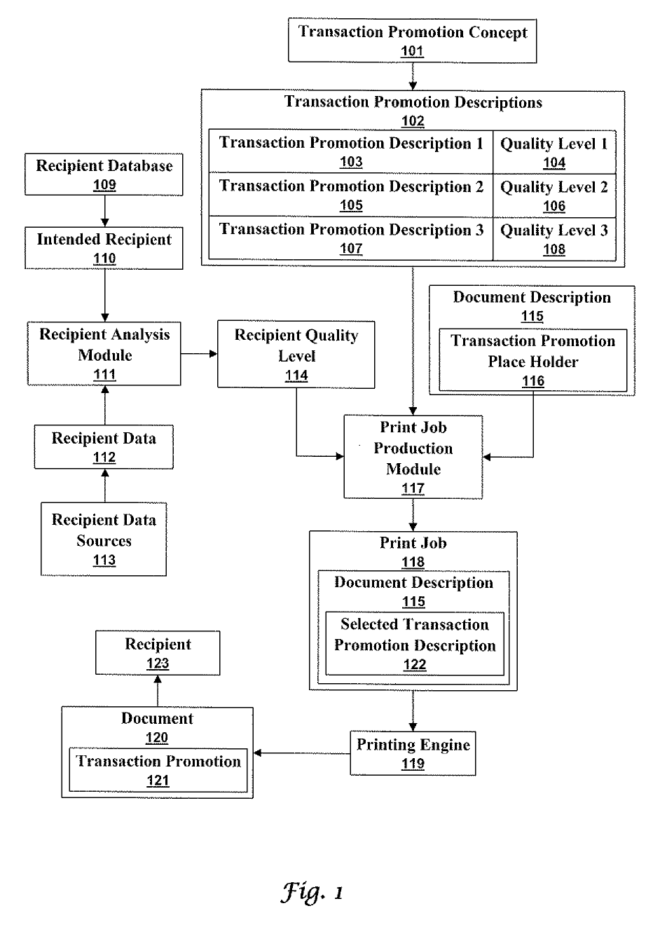

FIG. 1 illustrates a system presenting a document 120 containing a customized transaction promotion 121 to a recipient 123 in accordance with aspects of the embodiments. A person can come up with a transaction promotion concept 101 which is an idea for advertising a product or service. The transaction promotion concept 101 can then be expressed by producing transaction promotion descriptions 102. In the illustrated example, three transaction promotion descriptions 102 are produced and each has a different quality level. Transaction promotion description 1 103 has quality level 1 104. Transaction promotion description 2 105 has quality level 2 106. Transaction promotion description 3 107 has quality level 3 108.

Once produced, the transaction promotion descriptions 102 can be embedded into document descriptions. A document description 115 can contain a transaction promotion placeholder 116. The transaction promotion placeholder 116 can be populated with all the transaction promotion descriptions 102, one being eventually chosen, or can be populated by only the transaction promotion description that is chosen for an intended recipient 110.

The intended recipient 110 can be selected from a recipient database 109 and identified to a recipient analysis module 111. The recipient analysis module then collects and analyzes recipient data 112 collected from a variety of recipient data sources 113 to produce a recipient quality level 114.

A print job production module 117 can receive the recipient quality level 114, the document description 115, and one or more of the transaction promotion descriptions 102. The print job production module 117 selects the transaction promotion description having a quality level matching the recipient quality level 114 and produces a print job 118. The print job 118 contains the document description 115 and the selected transaction promotion description 122.

The print job 118 is passed to a printing engine 119 which produces the physical document 120 containing the transaction promotion. The transaction promotion has been printed with a quality level matching the recipient quality level 114. The document can be delivered to a recipient 123 who is hopefully also the intended recipient.

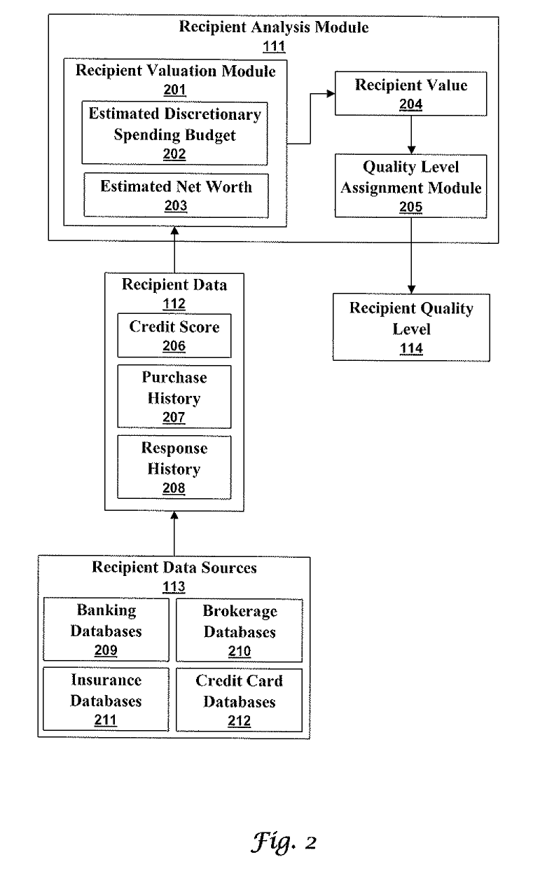

FIG. 2 illustrates a system determining a recipient quality level 114 in accordance with aspects of the embodiments. Upon receiving the identity of the intended recipient, the recipient analysis module 111 obtains recipient data 112 from a number of recipient data sources 113. Examples of the possible recipient data sources 113 are banking databases 209, brokerage databases 210, insurance databases 211, and credit card databases 212. Examples of the obtainable recipient data are the credit score 206, purchase history 207, and response history 208.

A recipient valuation module 201 can use the recipient data 112 to determine an estimated discretionary spending budget 202, an estimated net worth 203, or any of a variety of other inferences and estimates. The recipient valuation module produces a recipient value 204 which corresponds to the likelihood that the recipient will respond favorably to a transaction promotion. The quality level assignment module 205 converts the recipient value 204 into a recipient quality level 114. The recipient quality level 114 takes one of a small number of values matching the quality levels of the transaction promotion whereas the recipient value is not similarly constrained.

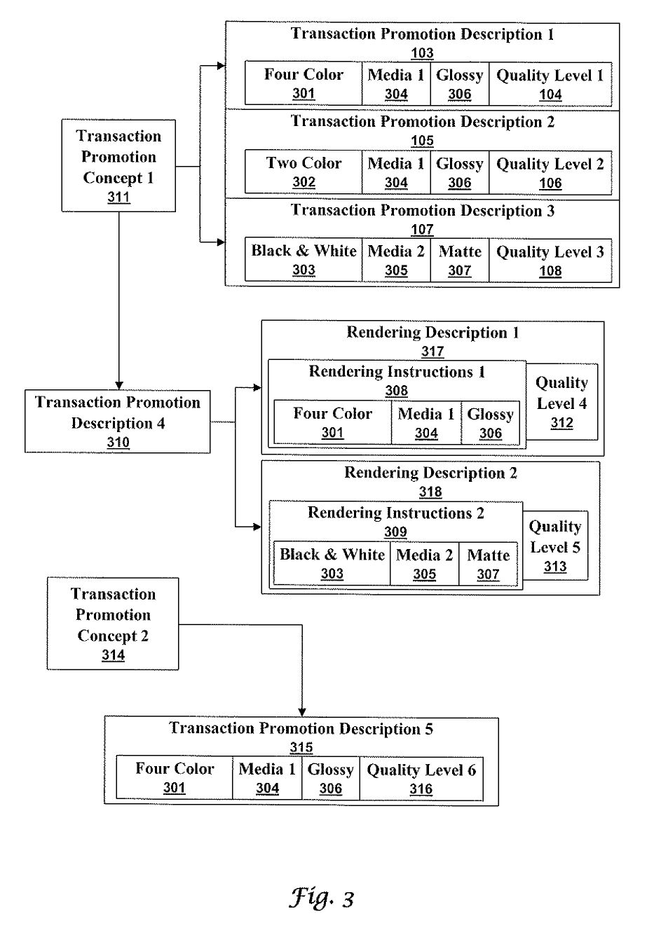

FIG. 3 illustrates producing transaction promotion descriptions from transaction promotion concepts in accordance with aspects of the embodiments. Transaction promotion concept 1 311 is expressed by each of a set of four transaction promotion descriptions. Transaction promotion description 1 103 having quality level 1 is for a four color 301, glossy 306 transaction promotion printed onto media 1 304. Transaction promotion description 2 105 having quality level 2 is for a two color 302, glossy 306 transaction promotion printed onto media 1 304. Transaction promotion description 3 107 having quality level 3 is for a black and white 303, matte 307 transaction promotion printed onto media 2 305. Media, such as media 1 304, can be specified by sets of media attributes, by media location, or simply by media weight. A set of media attributes can include media weight, brightness, opacity, smoothness, whiteness, and other attributes. A media location can simply be the printer tray hold the media.

Transaction promotion description 4 310 can be of quality level 4 312 or quality level 5 313. If the recipient quality level matches quality level 4 312 then rendering description 1 317 is selected and rendering instructions 1 308 are used to render transaction promotion 4 310 in glossy 306 four color 301 on media 1 304. If the recipient quality level matches quality level 5 313 then rendering description 2 318 is selected and rendering instructions 2 309 are used to render transaction promotion 4 310 in black and white 303, matte 307 onto media 2 305.

Alternatively, if the recipient quality level matches quality level 6 316 then transaction promotion 5 315 is selected. Transaction promotion description 5 315 expresses transaction promotion concept 2 314 and is to be printed in four color 301 glossy 306 onto media 1 304.

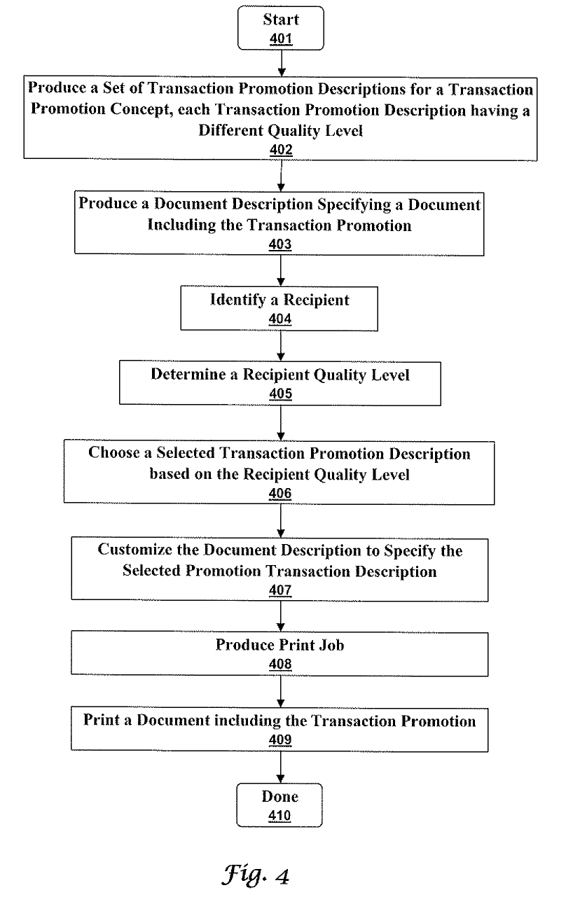

FIG. 4 illustrates a high level flow diagram of producing a document including a transaction promotion described by a set of transaction promotion descriptions in accordance with aspects of the embodiments. After the start 401, transaction promotion descriptions having different quality levels are produced to express a transaction promotion concept 402. Additionally, a document description is produced that specifies a document that will include a transaction promotion 403 before identifying a recipient 404 and determining a recipient quality level 405. The transaction promotion description with a quality level matching the recipient quality level is selected 406 and the document description customized to specify it 407. Finally, a print job is produced 408 for printing a document including the desired transaction promotion 409 before the process is done 410.

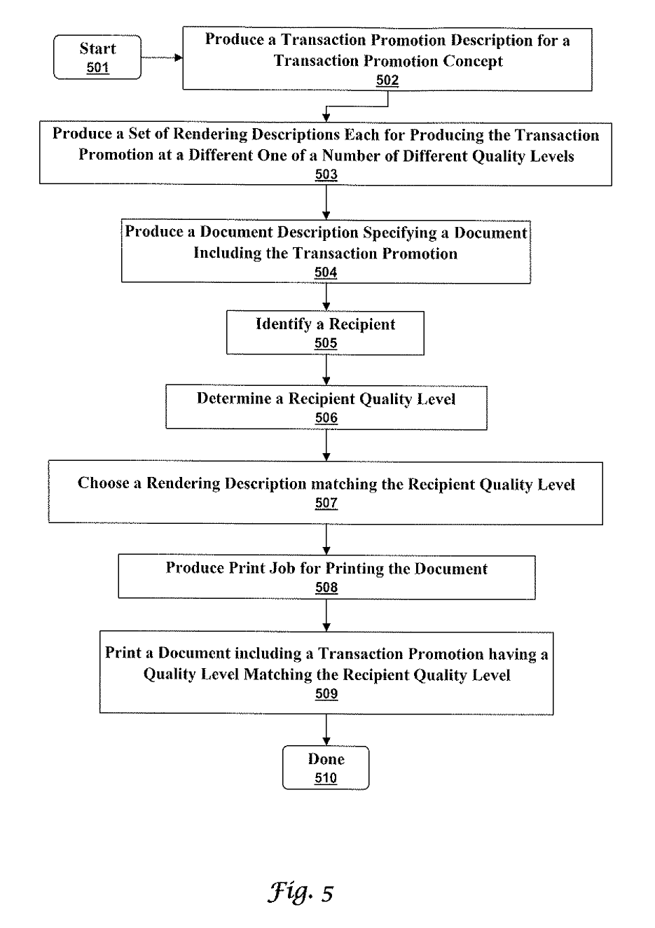

FIG. 5 illustrates a high level flow diagram of producing a document including a transaction promotion described by a single transaction promotion description rendered at differing quality levels in accordance with aspects of the embodiments. After the start 501, a transaction promotion description is produced for expressing a transaction promotion concept 502. A set of rendering descriptions is also produced such that the transaction promotion description can be rendered at a number of different quality levels 503. A document description specifying the transaction promotion can be produced 504 before identifying a recipient 505. A recipient quality level is determined and then used to select one of the rendering descriptions 507. Finally, a print job is produced 508 and a document is printed that includes a transaction promotion rendered at the desired quality level 509. The process is the done 510.

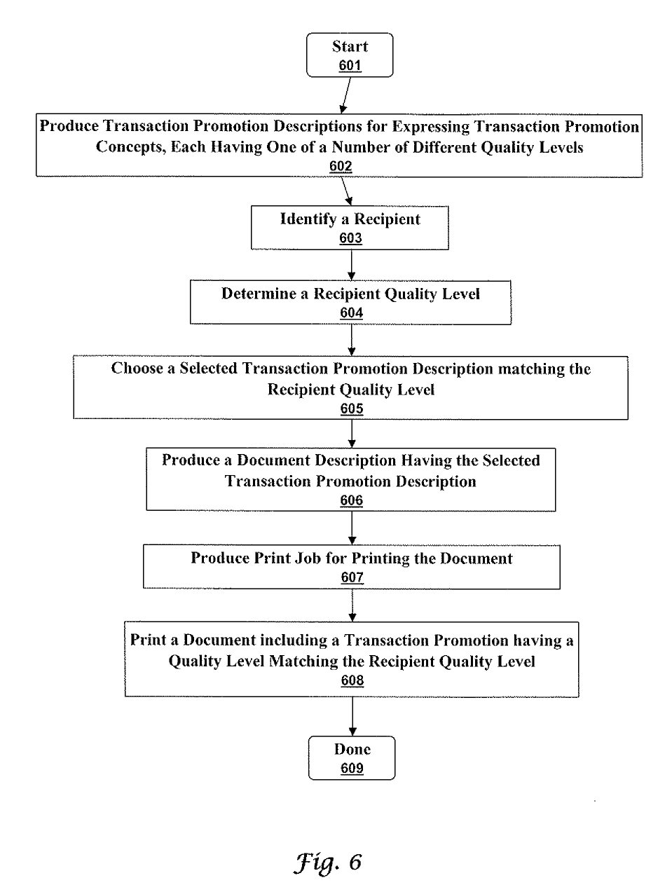

FIG. 6 illustrates a high level flow diagram of producing a document including a transaction promotion described by one of a set of transaction promotion descriptions in accordance with aspects of the embodiments. After the start 601, transaction promotion descriptions for a number of transaction promotion concepts are produced 602. Next, a recipient is identified 603 and a recipient quality level determined 604 which is used to select a transaction promotion description 605. A document description specifying or incorporating the selected transaction promotion description is produced 606 and used for the production of a print job 607. Finally, a document is printed that includes a transaction promotion having a quality level matching the recipient quality level 608 before the process is done 609.

The printed documents can be presented to recipients by mailing them through a government run postal service such as the United States Postal Service. Alternatively, other delivery methods or services such as commercial carriers, couriers, or directly serving papers on the recipient can be employed.

Embodiments can be implemented in the context of modules. In the computer programming arts, a module can be typically implemented as a collection of routines and data structures that performs particular tasks or implements a particular abstract data type. Modules generally can be composed of two parts. First, a software module may list the constants, data types, variable, routines and the like that can be accessed by other modules or routines. Second, a software module can be configured as an implementation, which can be private (i.e., accessible perhaps only to the module), and that contains the source code that actually implements the routines or subroutines upon which the module is based. Thus, for example, the term module, as utilized herein generally refers to software modules or implementations thereof. Such modules can be utilized separately or together to form a program product that can be implemented through signal-bearing media, including transmission media and recordable media.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method comprising: (different documents for different quality)
producing a plurality of transaction promotion descriptions for a transaction promotion wherein each one of a plurality of quality levels is associated with one of the transaction promotion descriptions;
producing a document description wherein the document description specifies a document that comprises the transaction promotion;
identifying a recipient;
determining a recipient quality level matching one of the quality levels;
producing a print job comprising instructions to print a document wherein the document is described by the document description; and
printing the document wherein the transaction promotion has a quality level matching the recipient quality level;

2. The method of claim 1 further comprising:
retrieving recipient data;
analyzing the recipient data to produce a recipient value; and
selecting the recipient quality level based on the recipient value.

3. The method of claim 2 wherein the recipient has a net worth and wherein analyzing the recipient data comprises producing an estimated net worth for the recipient.

4. The method of claim 2 wherein the recipient data comprises a credit score.

5. The method of claim 2 wherein the recipient data comprises a purchase history.

6. The method of claim 2 wherein the recipient data comprises a response history.

7. The method of claim 2 wherein analyzing the recipient data comprises estimating a discretionary spending budget.

8. The method of claim 1 wherein at least one of the transaction promotion descriptions specifies four color printing and another one of the transaction promotion descriptions specifies two color printing.

9. The method of claim 1 wherein at least one of the transaction promotion descriptions specifies a first set of media attributes and another one of the transaction promotion descriptions specifies a second set of media attributes that is different than the first set of media attributes.

10. The method of claim 1 wherein at least one of the transaction promotion descriptions specifies a glossy finishing and another one of the transaction promotion descriptions specifies a non glossy finishing.

11. The method of claim 1 further comprising:
retrieving recipient data comprising a credit score, a prior purchase history, and a prior response history;
analyzing the recipient data to estimate a discretionary spending budget and an estimated net worth for the recipient and to produce a recipient value based in part on the estimated net worth and on the discretionary spending budget; and
selecting the recipient quality level based on the recipient value,
wherein at least one of the transaction promotion descriptions specifies four color printing and another one of the transaction promotion descriptions specifies two color printing, wherein at least one of the transaction promotion descriptions specifies a first set of media attributes and another one of the transaction promotion descriptions specifies a second set of media attributes that is different than the first set of media attributes, and wherein at least one of the transaction promotion descriptions specifies a glossy finishing and another one of the transaction promotion descriptions specifies a non glossy finishing.

12. A method comprising: (different quality renderings for single document)
producing a transaction promotion description for a transaction promotion;
producing a plurality of rendering descriptions comprising rendering instructions wherein each one of a plurality of quality levels is associated with one of the rendering descriptions;
producing a document description wherein the document description specifies a document comprising the transaction promotion;
identifying a recipient;
determining a recipient quality level matching one of the quality levels;
producing a print job comprising instructions to print the document wherein the document is described by the document description; and
printing the document wherein the transaction promotion has a quality level matching the recipient quality level.

13. The method of claim 12 wherein at least one of the rendering descriptions specifies four color printing and another one of the rendering descriptions specifies two color printing.

14. The method of claim 12 wherein at least one of the rendering descriptions specifies a first set of media attributes and another one of the rendering descriptions specifies a second set of media attributes that is different than the first set of media attributes.

15. The method of claim 12 wherein at least one of the rendering descriptions specifies a glossy finishing and another one of the rendering descriptions specifies a non glossy finishing.

16. A method comprising: (different offerings for different customers)
producing a plurality of transaction promotion descriptions describing a plurality of transaction promotions and wherein each one of a plurality of quality levels are associated with one of the transaction promotion descriptions;
identifying a recipient;
determining a recipient quality level matching one of the quality levels;
choosing a selected promotion transaction description wherein the transaction promotion descriptions comprise the selected promotion transaction description and wherein the selected promotion transaction description is associated with a quality level matching the recipient quality level;
producing a document description wherein the document description comprises the selected promotion transaction description;
producing a print job comprising instructions to print a document wherein the document is described by the document description; and
printing the document wherein the document comprises a selected transaction promotion that is described by the selected promotion transaction description.

17. The method of claim 16 further comprising:
retrieving recipient data;
analyzing the recipient data to produce a recipient value; and
selecting the recipient quality level based on the recipient value.

18. The method of claim 17 wherein the recipient has a net worth and wherein analyzing the recipient data comprises producing an estimated net worth for the recipient.

19. The method of claim 17 wherein the recipient data comprises a credit score, a prior purchase history, and a prior response history.

20. The method of claim 17 wherein analyzing the recipient data comprises estimating a discretionary spending budget.
